(19) United States
(12) Patent Application Publication
(10) Pub. No.: US 2016/0324714 A1
(43) Pub. Date: Nov. 10, 2016

(54) WALKING ASSISTANCE APPARATUS

(71) Applicant: Bu Hwan JUNG, Busan (KR)

(72) Inventor: Bu Hwan JUNG, Busan (KR)

(21) Appl. No.: 15/108,980

(22) PCT Filed: Mar. 5, 2015
(86) PCT No.: PCT/KR2015/002139

§ 371 Date: Jun. 29, 2016

(30) Foreign Application Priority Data
Mar. 6, 2014 (KR) 10-2014-0026838
Mar. 4, 2015 (KR) 10/2015/0030469

(51) Int. Cl. A61H 3/00; A63B 23/04

(52) U.S. Cl. CPC A61H 3/008; A63B 23/04

(57) ABSTRACT

The present invention relates to a walking assistance device and, more specifically, to a walking assistance device serving for enabling the normal walking motion of a mobility impaired user, in which an elastic force providing means positioned between a fixed frame and a safety belt which the user wears control the extension or contraction of an elastic member within a predetermined range so as to ensure the safety of the user and a shock absorbing means is provided so as to exhibit a function for preventing the sudden stopping in the motion of a patient.

### TECHNICAL FIELD

The present invention relates to a walking assistance device and, more specifically, to a walking assistance device serving for enabling the normal walking motion of a mobility impaired user, in which an elastic force providing means positioned between a fixed frame and a safety belt, which a user wears, controls the extension or contraction of an elastic member within a predetermined range so as to ensure the safety of the user, and a shock absorbing means is provided so as to carry out a function for preventing sudden stopping in the motion of a patient.

### BACKGROUND ART

In general, a walking assistance device typically refers to a mechanism or a device that helps a patient, who cannot walk on his own due to various diseases, accidents and the like, and carry out physical rehabilitation treatment for walking.

For the people, who walk on their own two feet, they move with height differences in the normal walking process as well as certain displacement ranges from side to side during their normal walking.

FIG. 1 shows such height differences of the body of a walker and the body motion degrees from side to side during his or her walking, wherein normal people move about 4 cm from side to side with a height difference of about 5 cm during their normal walking.

For people with disabilities, the height difference during their walking becomes increased due to the length difference between their both legs and thus walking impacts become larger more uncomfortably. Therefore, they are likely to feel keenly the necessity of a walking assistance device in consideration such problems.

The ultimate goal of walking exercise is to enable people, who cannot walk normally, to walk as normally as possible.

Thus, in order to carry out the normal walking motion, it is necessary to relieve the impacts due to the horizontal and vertical motions during walking and simultaneously recover a human body to a normal walking state.

That is, in order to carry out walking motion close to the normal walking, it is necessary that a walking assistance device having a suspension function has to strongly hold a user from above so as to ensure the safety of the user when the user carries out walking motion in a state, in which the user wears a safety belt, and apply a certain elastic force in the horizontal and vertical directions.

Recently, there have been developed many walking assistance devices provided with safety devices, connected to rails, which are mounted on a ceiling, or fixed poles through ropes or chains so as to exhibit suspension functions such that users can carry out walking exercise while wearing the safety belts.

However, the prior art walking assistance devices still have problems that these devices are focused on the suspension functions in order to prevent users from being injured and the suspension devices are made from chains or ropes, which have no elasticity but are fixed in length, failing to perform the role as a walking assistance device.

For a disabled person, since the height change in his or her walking is greater than the vertical change range of a normal person, an impact applied to the body of the disable person becomes greater such that the body of the disabled person needs more protection. In spite of this problem, the prior art is simply provided with a suspension function for a human body. Therefore, it is necessary to provide a walking assistance device provided with an appropriate elastic means and an elastic shock absorbing means for such a height change. In addition, it is also necessary to provide a device for preventing such an elastic member from being extended beyond a predetermined length so as to prevent damage to the elastic member.

FIG. 2 illustrates a prior art walking assistance device. Referring to FIG. 2, a chain 18, which is a non-elastic member, is formed between a ring-shaped frame holding part 40 and a ring-shaped lower connection part 41. A safety belt 50 is formed to be provided to the waist of a user, wherein two suspension belts 51 are connected to an upper portion of the safety belt 50, suspension belt spacing means 30 are connected to upper end portions of the suspension belt upper at both sides thereof through suspension belt frame holding parts 42 and the suspension belt spacing means 30 are connected to the lower end portion of a chain 18 through a lower connection part 41, which is formed at the lower end portion of the chain 18.

In a state, in which a patient wears the device of FIG. 2, there is a problem that since the patient has to walk hung at a predetermined height, it is not possible to appropriately cope with the height change generated during the walking motion, failing to carry out normal walking training.

According to the present invention, there is suggested a walking assistance device provided with a means for exhibiting elasticity in order to help normal walking as well as a means for controlling the extension or contraction of an elastic means within a predetermined length range.

Meanwhile, even though there have been developed devices for coping with the height changes during walking by using motors or hydraulic devices, there are still problems that the devices are considerably expensive and cannot fully handle the problems of the different walking habits of users and the irregular situations generated during walking.

Therefore, the present invention is derived to provide a walking assistance device, which is provided with an elastic member for ensuring a height change close to that of normal walking, a constraint means for preventing the damage to the elastic member, a shock absorbing means for protecting the body of a patient and the like.

### DISCLOSURE

### Technical Problem

Accordingly, the present invention has been made in an effort to solve the above-mentioned problems occurring in the prior arts, and it is an objective of the present invention to provide a walking assistance device including an elastic force providing means, which can be readily provided to and used in a walking assistance device having a suspension function.

That is, the present invention is to provide a device, which provides elastic force for appropriately coping with the height change generated in the process of walking motion, and includes a constraint means for preventing the damage to an elastic member as well as a shock absorbing means for preventing the sudden stopping operation of the elastic member and the like, such that a patient can carry out walking training close to normal walking.

### Technical Solution

The present invention has below-mentioned means to solve the above problems.

That is, a walking assistance device, according to the present invention, includes an elastic force providing means, wherein the elastic force providing means includes: an elastic member 10, of which an upper portion is connected to a frame 60 of a walking motion assistance device and a lower portion is connected to a safety belt 50 which a user puts on his waist; and an elastic member constraint means 20 formed to neighbor the elastic member 10.

The elastic member and the elastic member constraint means may be formed in the shape of a rope or a spring.

The elastic member constraint means 20 is formed in the same vertical direction as the elastic member 10. The elastic member 10 may be formed to be spaced from the elastic member constraint means 20, or formed into a shape, in which the both end portions of the elastic member 10 are joined to the elastic member constraint means 20, or formed into a shape, in which the elastic member 10 is joined to one side position of the elastic member constraint means 20. The length of a portion in a body part of the elastic member constraint means 20, which is formed to neighbor the elastic member 10, is formed to be longer than a neutral state length of the elastic member 10, in which the elastic member 10 is neither extended nor contracted.

A suspension belt spacing means 30 may be further formed at a position between a safety belt 50, which a user wears, and the walking motion assistance device 60, such that an interval between one pair of suspension belts can be maintained as wide as the shoulder width of a user at the upper portions of the safety belt. In this case, the positions of the elastic member and the elastic member constraint means may be formed between the suspension belt spacing means 30 and the frame 60, or between the suspension belt spacing means 30 and the safety belt 50.

The walking assistance device is provided including the elastic force providing means, which is further provided with a shock absorbing means 15 in addition to the elastic member 10 and the elastic member constraint means 20.

That is, in the walking assistance device comprising the elastic force providing means, which includes: the elastic member 10, of which the upper portion is connected to the frame 60 of the walking motion assistance device and the lower portion is connected to the safety belt 50 which a user puts on his waist; the elastic member constraint means 20 vertically formed in parallel to the elastic member 10; and the shock absorbing means 15 vertically formed in parallel to the elastic member and made from an elastic material, the walking assistance device may be characterized in that: the shock absorbing means 15 is formed such that the neutral state length of the shock absorbing means 15, in which the shock absorbing means 15 is neither extended nor contracted, is longer than the neutral state length of the elastic member, in which the elastic member is neither extended nor contracted; and the elastic member constraint means 20 is formed such that the neutral state length of the elastic member constraint means 20, in which the elastic member constraint means 20 is neither extended nor contracted, is longer than the neutral state length of the shock absorbing means, in which the shock absorbing means is neither extended nor contracted.

A walking assistance device provided with another elastic force providing means may be formed as follows.

That is, in a walking assistance device, which is connected to a frame 60 of the walking assistance device in the upward direction and a safety belt 50 for surrounding a body part of a patient in the downward direction, the walking assistance device may comprise an elastic force providing means 200, which includes: an elastic member constraint means 210 having a vertical movement part 220, which is provided to an internal space of the elastic member constraint means 210 and coupled to an upper end portion of a lower connection part 230; a vertical movement part 220 provided to the inside of the elastic member constraint means so as to move vertically; a lower connection part 230 coupled to the lower side of the vertical movement part so as to be connected to an external member at one side; and a lower elastic member 240, of which one side is coupled to a lower end of the vertical movement part 220 and the other side is coupled to a lower side surface in the elastic member constraint means 210 so as to provide elastic force.

A shock absorbing means 245, 252 may be formed in the elastic member constraint means 210 and has elastic force so as to generate elastic force simultaneously with the lower elastic member 240 from a position where the vertical movement part 220 is moved downwards by a predetermined distance and comes into contact with the shock absorbing means.

It is also possible to realize a walking assistance device comprising an elastic force providing means, which has an upper elastic member formed at the upper portion of the vertical movement part.

That is, in the walking assistance device, which is connected to the frame 60 of the assistance device in the upward direction and the safety belt 50 for surrounding a body part of a patient in the downward direction, the walking assistance device may comprise an elastic force providing means 200, which includes: the elastic member constraint means 210 having the vertical movement part 220, which is provided to the internal space of the elastic member constraint means 210 and coupled to the upper end portion of the lower connection part 230; the vertical movement part 220 provided to the inside of the elastic member constraint means so as to move vertically; the lower connection part 230 coupled to the lower side of the vertical movement part so as to be connected to an external member at one side; and an upper elastic member 250, of which one side is coupled to the upper end of the vertical movement part 220 so as to provide elastic force to the vertical movement part.

A shock absorbing means 257 may be further formed to be longer than the length of the upper elastic member so as to be connected to the upper elastic member 250 in parallel to the upper elastic member 250 and have elastic force so as to generate elastic force simultaneously with the upper elastic member 250 after the vertical movement part 220 is extended by a predetermined length. Meanwhile, it is also possible to provide at least one of a scale 260 for checking a movement distance of the vertical movement part or a digital indicator 270 for digitally indicating the movement distance of the vertical movement part, which is formed on the outer surface of the elastic force providing means 200.

### Advantageous Effects

According to the present invention, it is possible to provide the elastic force providing means between the assistance device frame and the safety belt, which a user wears, so as to generate elastic force for appropriately coping with the height change generated in the process of walking motion in a safety-ensured situation, wherein the movement amount of the elastic member is constrained in the elastic member constraint means such that walking motion close to the normal walking can be carried out in a safety-ensured state.

In addition, the shock absorbing means is provided to prevent the sudden stopping of the operation of the elastic member so as to protect the body of a patient.

Furthermore, the walking assistance device according to the present invention has the advantages of such a simple structure and easy installation to any existing products. Therefore, the walking assistance device according to the present invention may replace the prior art expensive walking assistance device, incurring economical cost saving effect.

Furthermore, the scale or the digital indicator is formed on the outer surface of the elastic force providing means according to the present invention such that the height change can be checked with the naked eye. Therefore, it is possible to immediately check whether abnormal walking motion is carried out and use corresponding information as search data subordinately.

The present invention has an advantage that the walking assistance device has high versatile applicability since the device can be sufficiently applied to a robot, which carries out walking motion with two feet means.

The elastic force providing means including the elastic means and the elastic member constraint means in the walking assistance device, according to the present invention, is not necessarily fixed to the lower portion of such a fixed frame but may be also provided to the lower portions of wheels, which are provided to the lower portions of the frame so as to roll as a user moves.

### DESCRIPTION OF DRAWINGS

FIG. 1 shows analysis materials on the vertical and horizontal movement of a human body during the walking of a normal person.

FIG. 2 is a view for showing an example of the use of a prior art walking assistance device.

FIG. 3 shows a walking assistance device provided with an elastic force providing means 100 according to a preferred embodiment of the present invention.

FIG. 4 is a view for explaining a first modification example of the elastic force providing means 100 shown in FIG. 3.

FIG. 5 is a view for explaining a second modification example of the elastic force providing means 100 shown in FIG. 3.

FIG. 6 is a view for explaining a third modification example of the elastic force providing means 100 shown in FIG. 3.

FIG. 7 is a view for explaining a fourth modification example of the elastic force providing means 100 shown in FIG. 3.

FIG. 8 shows a walking assistance device provided with an elastic force providing means 200 according to another preferred embodiment of the present invention.

FIG. 9 to FIG. 11 are views for showing examples, in which the mounting position of the elastic force providing means 200 of FIG. 8 is changed.

FIG. 12 is a view for explaining the internal structure of the elastic force providing means 200 of FIG. 8.

FIG. 13 is a view for explaining a first modification example of the elastic force providing means 200 shown in FIG. 12.

FIG. 14 is a view for explaining a second modification example of the elastic force providing means 200 shown in FIG. 12.

FIG. 15 is a view for explaining a third modification example of the elastic force providing means 200 shown in FIG. 12.

FIG. 16 is a view for expressing a scale, which may be formed on the elastic force providing means 200 shown in FIG. 12.

FIG. 17 is a view for expressing a digital indicator, which may be formed on the elastic force providing means 200 shown in FIG. 12.

FIG. 18 is a view for explaining a fourth modification example of the elastic force providing means 200 shown in FIG. 12.

FIG. 19 is a view for explaining the role of a shock absorbing means, and

FIG. 20 is a view for explaining a rope-shaped shock absorbing means 15, which may be further provided to the elastic force providing means 100 shown in FIG. 3.

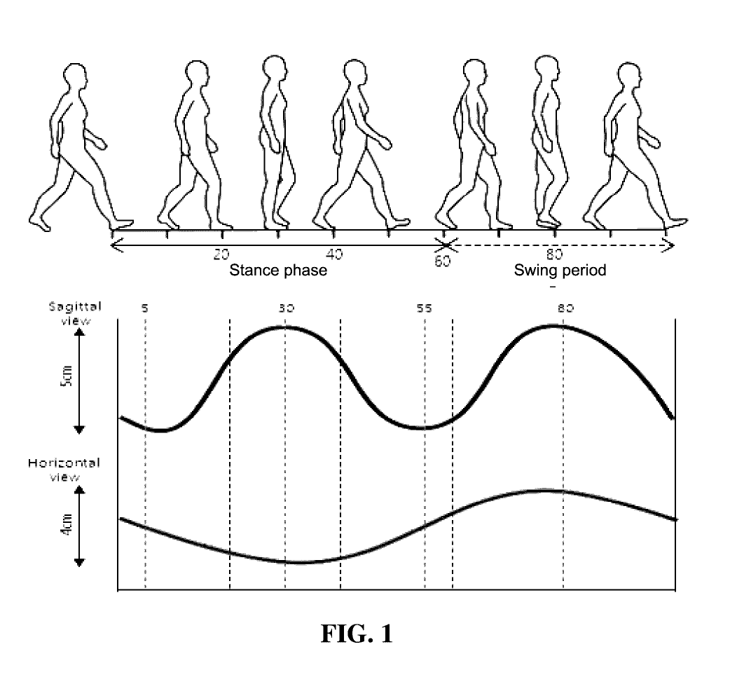

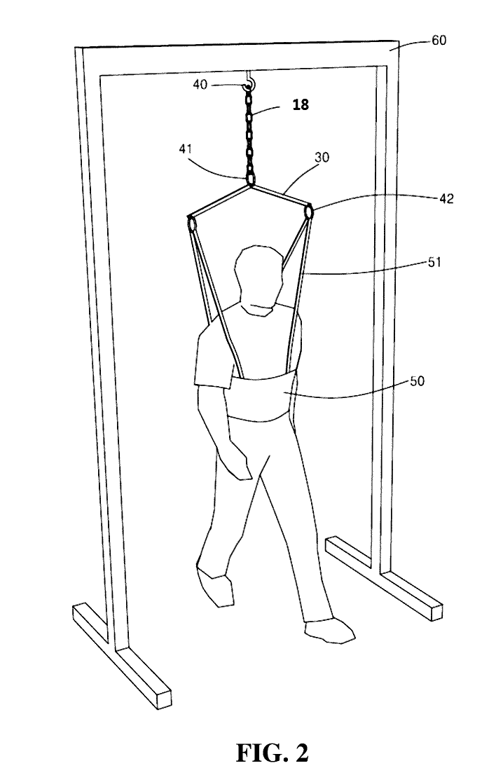

### MODE FOR INVENTION

Hereinafter, a walking assistance device according to the present invention will be described in detail with reference to accompanying drawings.

In the explaining of the features of the present invention, elements which carry out the same functions may be indicated by the same names even though the objects have different shapes.

In addition, the same components have the same reference numerals even though they are illustrated in different figures.

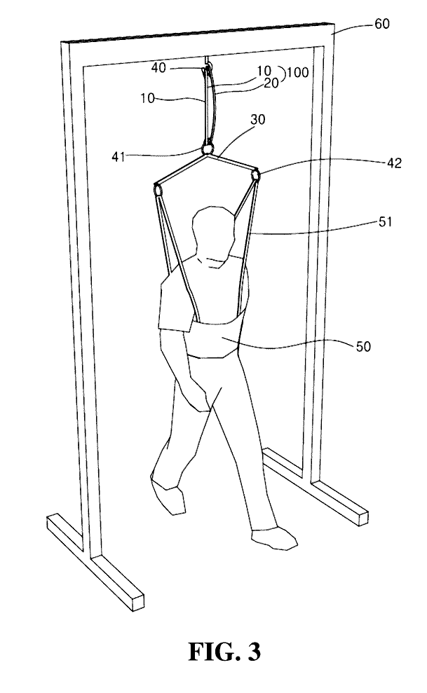

FIG. 3 expresses a walking training figure of a patient by using a walking assistance device provided with an elastic force providing means according to a preferred embodiment of the present invention.

The configuration of the present embodiment is explained hereinafter.

That is, FIG. 3 shows a frame holding part 40 coupled to the lower portion of a frame 60 of a walking motion assistance device having a suspension function, an elastic member 10 coupled with the frame holding part 40 at the upper portion thereof, an elastic member constraint means 20 coupled with the frame holding part 40 at the upper portion thereof, a lower connection part 41 for connecting the elastic member 10 to the lower portion of the elastic member constraint means 20, a suspension belt spacing means 30 coupled to the lower connection part 41, a suspension belt frame holding part 42 provided at the lower portion of the suspension belt spacing means 30, a suspension belt 51 coupled at the lower portion of the suspension belt frame holding part 42, and a safety belt 50 supported by the suspension belt 51 and which a user wears.

It is natural that elements in the shape of a connection ring in FIG. 3, for example, the frame holding part 40, the lower connection part 41, the suspension belt frame holding part 42 and the like may be of course modified in shape from those shown in FIG. 3, wherein it should be noted that the elements 40, 41 and 42 may be omitted from essential constituent elements.

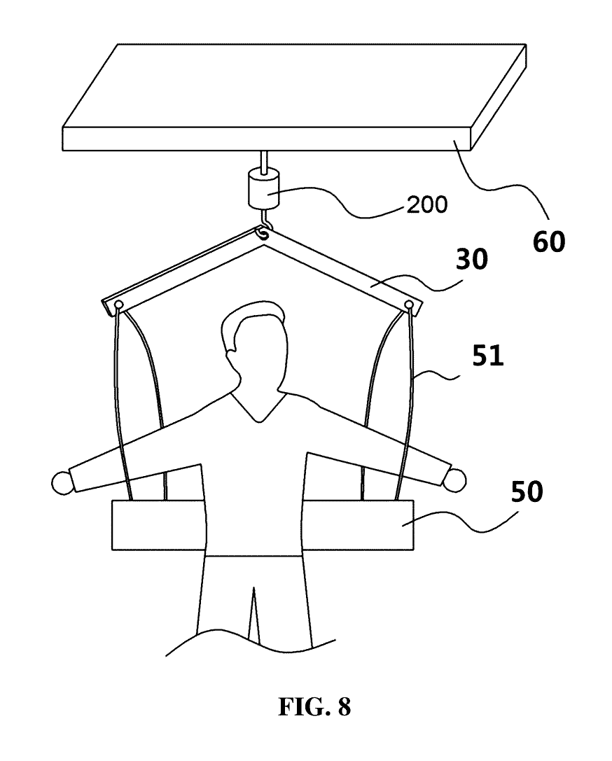

The most principal feature of the present invention resides at a walking training assistance device, which is provided with an elastic force providing means including the elastic member and the elastic member constraint means for restraining the motion of the elastic member. As the most basic shape of the elastic force providing means, there may be suggested an elastic force providing means 100 including the elastic member 10 and the elastic member constraint means 20, which are in the shape of a rope, as shown in FIG. 3. It is also possible to provide an elastic force providing means 200, which includes an elastic member provided inside as shown in FIG. 8, as another shape of such an elastic force providing means.

The rope-shaped elastic member 10 may be replaced with any other element having elastic force such as a spring and the like. The elastic force providing means 200 shown in FIG. 8 will be described hereinafter and, first, the walking assistance device provided with the rope-shaped elastic force providing means as shown in FIG. 3 to FIG. 7 will be described.

Meanwhile, the elastic force providing means including the elastic member 10 and the elastic member constraint means 20, according to the present invention, is not necessarily provided to the lower portion of the frame, which is fixed.

Even though it is not shown, it is also possible to further provide wheel means at one side of the frame so as to roll along the body of the frame 60 and provide the elastic force providing means including the elastic member 10 and the elastic member constraint means 20 to the lower portions of the wheel means. In this case, the wheels roll as a user walks and the elastic force providing means, which are coupled to the wheels, move together with the wheels such that elasticity can be exhibited in response to the height change of the body of the user during his or her walking.

When the user walks, horizontal and vertical motions are generated. Therefore, it is necessary to ensure walking close to normal walking while the body of the user is maintained without separation from the walking assistance device.

As described above, the feature of the present invention resides at the provision of the elastic force providing means for ensuring the motions of the user, close to normal walking. As a basic configuration of the elastic force providing means, the elastic force providing means includes the elastic member 10 and the elastic member constraint means 20 for preventing the damage to the elastic member 10 due to excessive extension.

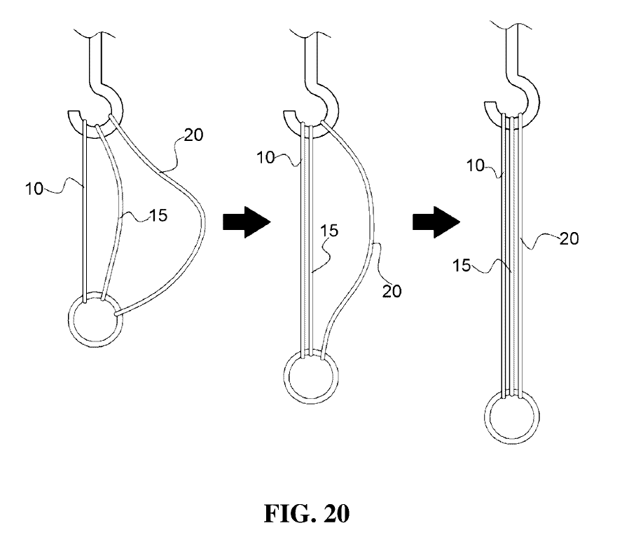

Even though described hereinafter, a shock absorbing means 15 (see FIG. 20) may be further provided as a constituent element of the elastic providing means 100, in addition to the elastic member 10 and the elastic member constraint means 20, so as to prevent the sudden stopping operation of the elastic member.

The elastic member constraint means 20 functions as a stopper and has to be formed to be longer than the neutral state length of the elastic member 10, in which the elastic member 10 is neither extended nor contracted.

The elastic member constraint means 20 has to be made from a non-elastic material, of which length is not extendable, and which has a strength capable of bearing the weight of a user body.

The elastic member constraint means 20 is formed in the downward direction in parallel with the elastic member 10 and prevents the elastic member 10 from being damaged and broken due to the downward extension beyond a predetermined length by the weight of the user body, thereby serving to protect the equipment and the body of the patient.

The elastic member 10 and the elastic member constraint means 20 may be provided in the number of at least one or two or more, respectively, so as to be coupled to the frame holding part 40 and the lower connection part 41.

It is stands to reason that the elastic member 10 and the elastic member constraint means 20 may be separately held on additionally provided frame holding parts (not shown) and lower connection parts (not shown) rather than held on the same single frame holding part 40 and the same single lower connection part 41.

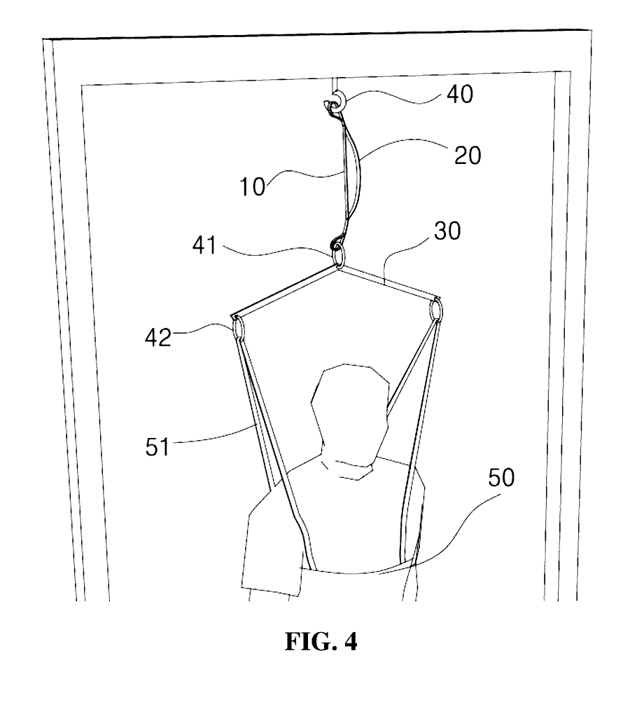

FIG. 4 shows that the elastic member 10 and the elastic member constraint means 20 may be formed in a shape, in which the elastic member 10 and the elastic member constraint means 20 are not formed as separated bodies from each other as shown in FIG. 3 but are formed at two positions in the middle portion and the upper and lower portions of the body of the elastic member constraint means 20 so as to be respectively coupled with the lower end portion and the upper end portion of the elastic member 10. Herein, the length of the portion where the elastic member constraint means 20 and the elastic member 10 are in contact with each other at two upper and lower positions in FIG. 4 has to satisfy the following condition.

The length of the elastic member constraint means 20 has to be longer than the length of elastic member 10, which is neither extended nor compressed, that is, the neutral state length of the elastic member 10.

As described above, the role of the elastic member constraint means 20 is to prevent the extension of the elastic member 10 beyond a predetermined length. Therefore, the above condition is required.

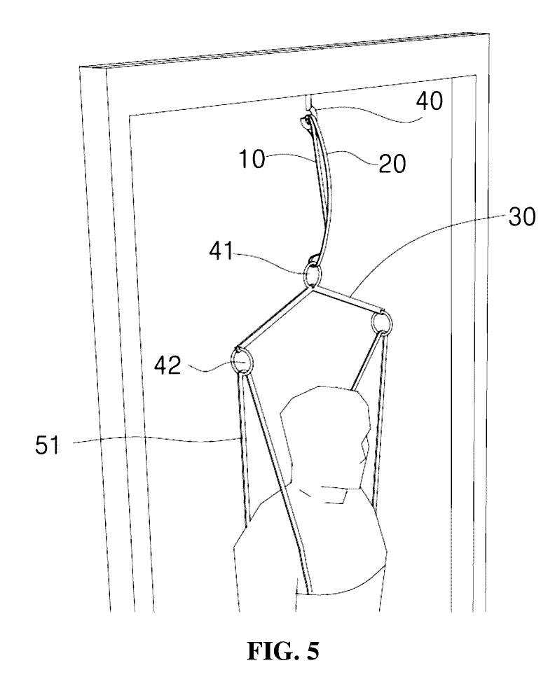

FIG. 5 illustrates the elastic member 10 and the elastic member constraint means 20, which are coupled to each other in another shape different from those shown in FIG. 3 and FIG. 4.

That is, it is possible that only the lower side end portion of the elastic member 10 is joined to one side of the body of the elastic member constraint means 20 and the upper end portion of the elastic member 10 is held on the frame holding part 40.

To the contrary, even though it is not shown, it is also possible that only the upper side end portion of the elastic member 10 is joined to one side of the body of the elastic member constraint means 20 and the lower end portion of the elastic member 10 is held on the frame holding part 40.

Of course, the length of the portion where the elastic member constraint means and the elastic member neighbor each other as shown in FIG. 5 also has to satisfy the above-mentioned length condition.

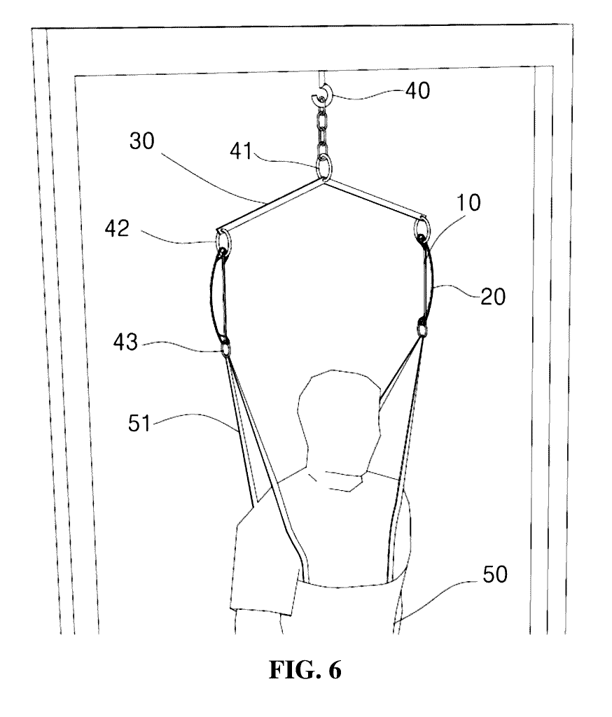

FIG. 6 illustrates another positions of the elastic member 10 and the elastic member constraint means 20, which are different from those of the embodiment shown in FIG. 3.

That is, the positions of the elastic member and the elastic member constraint means are respectively formed downwards at both ends of the suspension belt spacing means 30. The one pair of the suspension belts 51 are coupled at the lower portions of another suspension belt frame holding parts 43, which are coupled with the lower end portions of the elastic member 10 and the elastic member constraint means 20.

Meanwhile, the name of the suspension belt spacing means 30 is originated from the function of maintaining an interval between the one pair of suspension belts 51 correspondingly to the shoulder width of a user.

It is also possible to provide the elastic member 10 and the elastic member constraint means 20 between the both end portions of the suspension belt spacing means 30 and the suspension belts 51, and provide a plurality of the elastic members 10 and a plurality of the elastic member constraint means 20 according to the shape of the suspension belt spacing means 30.

Of course, it is possible to form the shape of the elastic member 10 and the elastic member constraint means 20 illustrated in FIG. 6 into the mutually joined shape at one or two positions as shown in FIG. 4 or FIG. 5.

That is, the elastic member 10 and the elastic member constraint means 20 may be changed in the positions thereof so as to be provided at several portions of the walking assistance device, wherein the both can be provided separately from each other or in a shape, in which the both are joined at least partially.

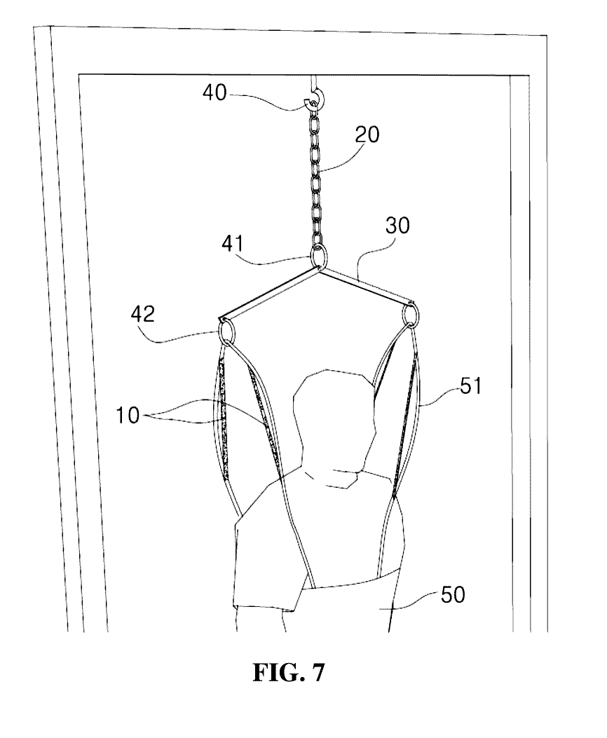

FIG. 7 illustrates another embodiment, in which the elastic member and the elastic member constraint means are provided in another shape.

The present embodiment has features, wherein the elastic member constraint means 20 is not separately provided to the lower portion of the suspension belt spacing means 30 and, instead, a part of the body of the suspension belt 51 is used as a portion for exhibiting the function of an elastic member constraint means. Herein, the suspension belts 51 have to be made from a non-elastic material. That is, in the body of the suspension belt, the upper and lower portions of the elastic member are joined in predetermined separated portions. Even though four elastic members 10 are provided in consideration of the balance in the back and forth directions and in the right and left directions in the embodiment, the number of the elastic member is not necessarily limited thereto.

Referring to FIG. 7, the length relations of the mutually joined corresponding parts of the elastic member 10 and the suspension belt 51 have to be satisfied as described above, wherein the length of the suspension belt, which is a non-elastic member, has to be longer than the neutral state length of the elastic member 10, in which the elastic member 10 is neither extended nor contracted.

Of course, differently from the embodiment shown in FIG. 7, it is also possible that one end portion of the elastic member 10 is not coupled at one side of the upper portion of the suspension belt 51 but is coupled to a suspension belt frame holding part 42 (not shown), which is connected to the suspension belt spacing means 30.

FIG. 8 illustrates a walking assistance device provided with an elastic force providing means 200 according to another embodiment of the present invention.

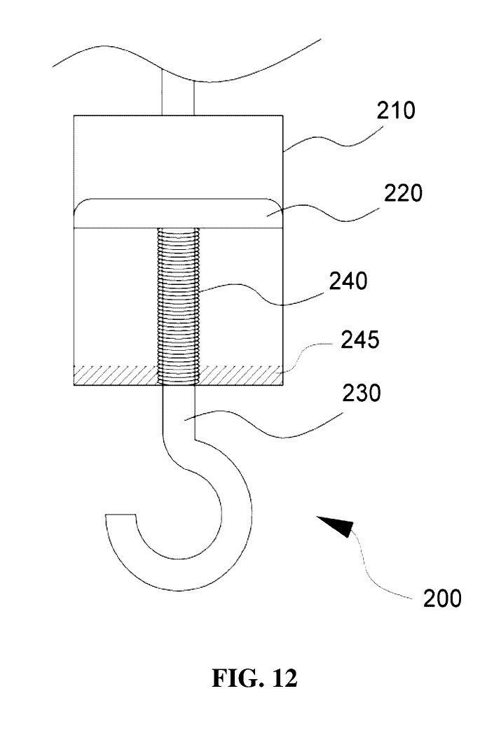

FIG. 12 expresses the interior parts of the elastic force providing means 200 in detail.

Meanwhile, the walking motion frame 60 is very schematically illustrated in FIG. 8 to FIG. 10.

Even though FIG. 3 expresses the elastic force providing means 100 including the elastic member 10 and the elastic member constraint means 20, which are formed in the shape of a string, FIG. 8 and FIG. 12 show the elastic force providing means 200 in a different structure therefrom.

The elastic force providing means 200, according to the present embodiment, includes an elastic member constraint means 210, a vertical movement part 220, a lower connection part 230 and a lower elastic member 240.

The name of the lower elastic member 240 means an elastic member, which is formed in the downward direction of the vertical movement part 220. The lower elastic member is not necessarily formed in the shape of a spring and can be made from a rubber material or any other materials having elasticity.

The upper portion of the lower connection part 230 body is positioned in the elastic member constraint means 210 and the lower portion of the lower connection part 230 is exposed to the outside such that the lower connection part 230 moves together with the vertical movement part 220 according to the movement of the vertical movement part 220. It is preferable that a hole is formed in the bottom surface of the elastic member constraint means 210 such that the upper portion of the body of the lower connection part 230 can exit through the hole.

If external force, for example, the weight of the user is applied to the lower connection part 230, which is coupled at the lower side of the vertical movement part 220, the vertical movement part 220 moves in the vertical direction.

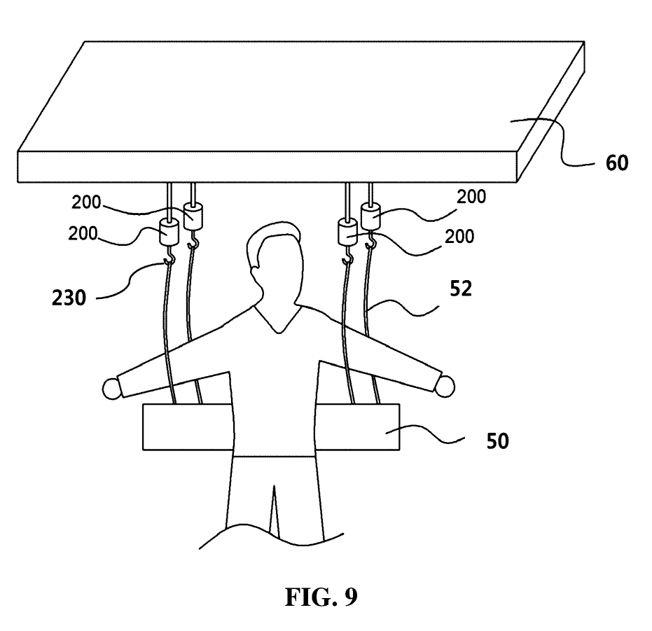

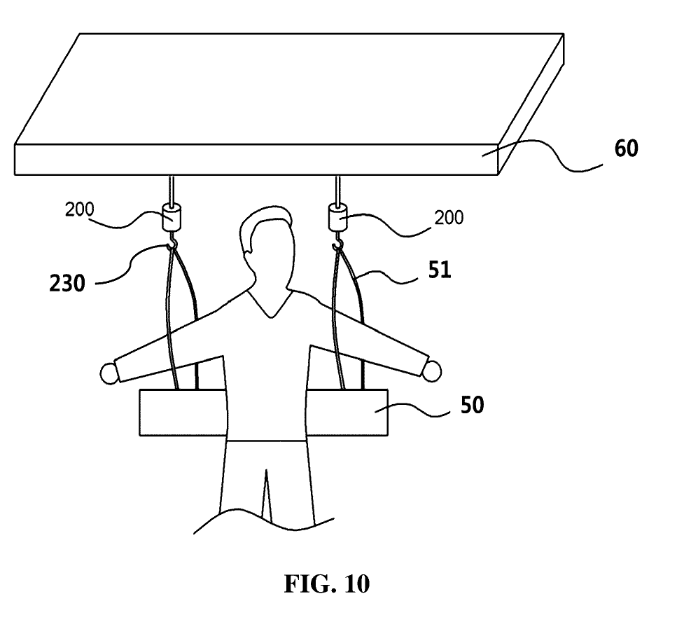

The lower connection part 230 may be connected to the suspension belt spacing means 30 as shown in FIG. 8 or the suspension belts 51, 52 as shown in FIG. 9 and FIG. 10.

Whenever a user carries out walking motion, the lower elastic member 240 is extended or contracted repetitively at each step of the user.

The lower elastic member 240, which exhibits elastic force in response to the height change generated in the process of the walking motion of the user, may be fixed to the lower end of the vertical movement part 220 at one side and to the lower side surface in the elastic member constraint means 210 at the other side.

It is preferable that the lower elastic member 240 is formed along the periphery of the upper portion of the body of the lower connection part 230, which is formed in the elastic member constraint means 210.

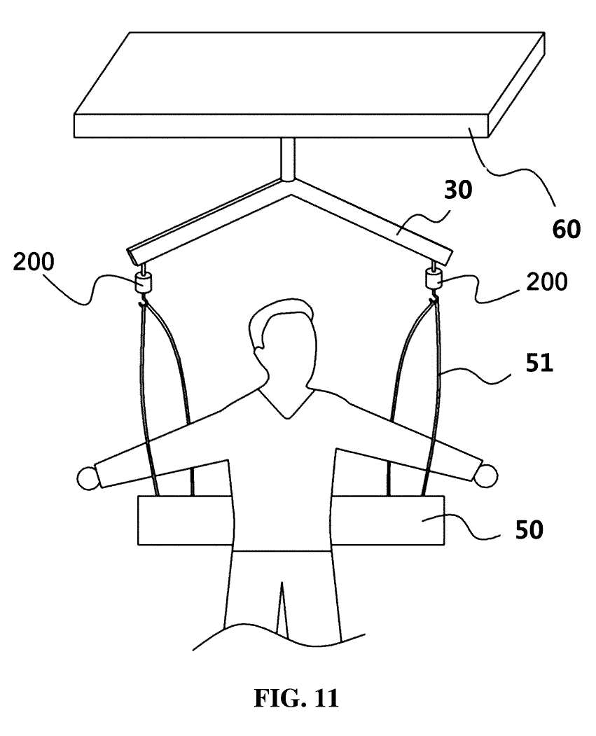

The elastic force providing means 200 of FIG. 12 may be also provided between the both end portions of the suspension belt 51 and the suspension belt spacing means 30 as shown in FIG. 11.

Further, as illustrated in FIG. 9 and FIG. 10, the elastic force providing means 200 may be directly formed at a position between the suspension belt 51, 52 and the frame 60 without the suspension belt spacing means 30 and the number of the elastic force providing means 200 may be adjusted to one or two or more.

Referring to FIG. 12, the lower elastic member 240 serving as an elastic member is provided at the lower side of the vertical movement part 220 so as to exhibit elastic force in the upward direction if the vertical movement part 220 moves in the downward direction by the weight of the user.

It is preferable that the elastic member constraint means 210 is formed in the shape of a cylinder but not necessarily limited thereto. The lower side portion of the lower connection part 230 and the upper side portion of the vertical movement part 220 are coupled in the elastic member constraint means 210.

The elastic member constraint means 210 protects the vertical movement part 220 and the lower elastic member 240 from the outside.

In addition, it is possible to further provide a shock absorbing means 245, which is made from an elastic material into a shape of a pad, on the inner bottom surface of the elastic member constraint means 210. The shock absorbing means is decreased in height if a load is applied from the outside.

The mounting purpose of the shock absorbing means 245 is mentioned below.

That is, the shock absorbing means 245 is provided to prevent the sudden stopping of the vertical movement part 220 such that the lowering speed of the vertical movement part 220 is reduced and then the lowering of the vertical movement part 220 is gradually stopped, since the body of the user can be imposed a burden if the vertical movement part 220 is suddenly stopped in the lowering.

That is, if the weight of the user is applied to the vertical movement part 220, which is connected to the lower connection part 230, then the vertical movement part is moved downwards. At this time, the vertical movement part is moved downwards, against the resistance of the elastic force by the lower elastic member 240 having a predetermined elastic coefficient.

If the vertical movement part 220 comes into contact with the shock absorbing means 245, which is the elastic member having a predetermined elastic coefficient, in the downward movement, the vertical movement part is simultaneously applied with the elastic force of both of the lower elastic member 240 and the shock absorbing means 245 such that the lowering speed of the vertical movement part 220 is decreased.

Mostly, patients using the present invention have vertebral disease and thus the role of the shock absorbing means 245 is very important.

The shock absorbing means may be applied to the rope-shaped elastic force providing means as shown in FIG. 3 to FIG. 7.

That is, even though only the elastic member 10 and the elastic member constraint means 20, which is the non-elastic member, are mentioned for explaining the structure of the elastic force providing means with reference to FIG. 3 to FIG. 7, it is also possible to apply the rope-shaped shock absorbing means 15, which is longer than the elastic member 10 and shorter than the elastic member constraint means 20 as shown in FIG. 20, to the embodiment shown in FIG. 3 to FIG. 7.

The rope-shaped shock absorbing means has to be made from an elastic material so as to be extended or contracted.

As illustrated in FIG. 20, the elastic member 10 is extended in length by an external load and the extending speed of the elastic member 10 is decreased from a time point when the length of the elastic member 10 becomes the same as the length of the shock absorbing means 15. The reason is that the elastic force of both of the elastic member 10 and the shock absorbing means 15 simultaneously acts together as resistance force with respect to the external load.

As shown in the right side of FIG. 20, if the elastic member 10 and the shock absorbing means 15 are further extended such that the lengths of the elastic member 10 and the shock absorbing means 15 become the same as the length of the elastic member constraint means 20, then the elastic member and the shock absorbing means cannot be extended any more by the external load. To summarize the function of the device illustrated in FIG. 12, the lower elastic member 240 exhibits elastic force and the elastic force of the shock absorbing means 245 is added thereto after the elastic member is displaced by a predetermined amount such that the impact applied to the patient can be minimized.

Meanwhile, even though it is not illustrated, a guide groove is preferably formed in the inner side wall surface of the elastic member constraint means so as to guide the vertical movement of the vertical movement part during the vertical movement of the vertical movement part.

It is also possible to use an elastic member made from a rubber material or any other material having elasticity instead of the lower elastic member 240 of FIG. 12, and use an elastic member made from a rubber material, a spring or any other material having elasticity instead of the shock absorbing means 245.

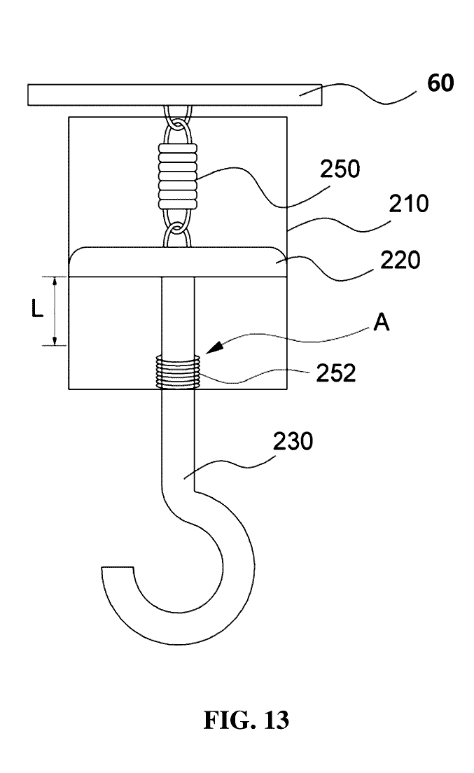

FIG. 13 illustrates an upper elastic member 250 and a shock absorbing means 252, which are formed at different positions from the corresponding features illustrated in FIG. 12. That is, the upper elastic member 250 is positioned at the upper portion of the vertical movement part 220 and the shock absorbing means 252 is positioned at the lower side of the vertical movement part 220. The shock absorbing means 252 is formed in the shape of a spring rather than the pad.

The name of the upper elastic member 250 means that the elastic member 250 is provided in the upward direction of the vertical movement part 220.

The lower side of the upper elastic member 250 is coupled at the upper end of the vertical movement part 220, and the upper side of the upper elastic member 250 is coupled at the lower side of the frame 60.

The vertical movement part 220 is applied with the resistance by the elastic force of the upper elastic member 250, which has an elastic coefficient k1, while the vertical movement part 220 moves downwards by a length L by the weight of the user.

The vertical movement part 220 comes into contact with the shock absorbing means 252 at a position A, wherein, from this position A, the vertical movement part 220 is further applied with the resistance by the elasticity of the shock absorbing means 252, which has an elastic coefficient k2, such that the downward movement speed of the vertical movement part 220 is decreased. The vertical movement part is finally stopped through the decrease of the downward movement speed.

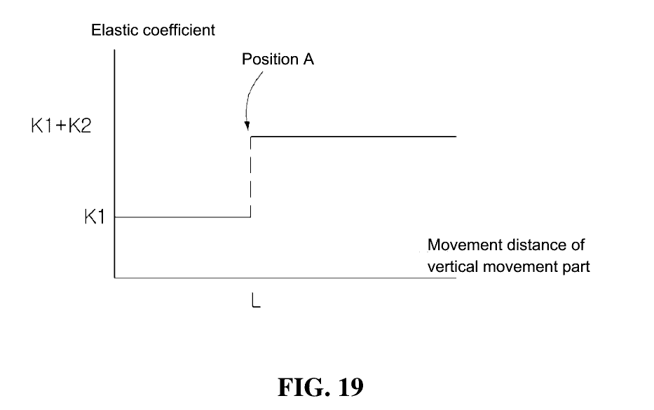

FIG. 19 shows that the vertical movement part 220 is applied with the resistance by the upper elastic member 250, which has the elastic coefficient k1, in the downward movement before the length L and then simultaneously applied with the resistance by the elastic force of the shock absorbing means 252, which has the elastic coefficient k2, from the position A.

That is, the role of the shock absorbing means 252 is the same as the pad-shaped shock absorbing means 245 of FIG. 3 so as to decrease the downward movement speed of the vertical movement part 220 and then to gradually stop the vertical movement part 220,

As shown in FIG. 13, it is preferable that the shock absorbing means 252 is formed to be wound on the outer circumferential surface of the upper side portion of the lower connection part 230, but the shock absorbing means 252 may be formed at any other position in the elastic member constraint means 210 and modified into an object in another shape as far as the object can exhibit elasticity.

If a user wears the safety belt 50 of the walking assistance device structured as above and walks, the vertical movement part 220 moves in the vertical direction and naturally exhibits elastic force in response to the height change during the walking motion. The common features of the embodiments illustrated in FIG. 12 and FIG. 13 may be summarized as follows.

That is, even though the positions and shapes of the elastic members 240 and 250 are slightly different from each other, the elastic members 240 and 250 are the same as each other in that the elastic members 240 and 250 exhibit elasticity according to the movement of the vertical movement part 220.

In addition, the shock absorbing means 245 and 252 are the same as each other in that the shock absorbing means 245 and 252 are formed to control the movement speed of the vertical movement part 220 such that the vertical movement part 220, which moves at a relatively high speed for a predetermined length, is decreased in the displacement speed after the contact with the shock absorbing means 245 and 252 so as to be gradually stopped.

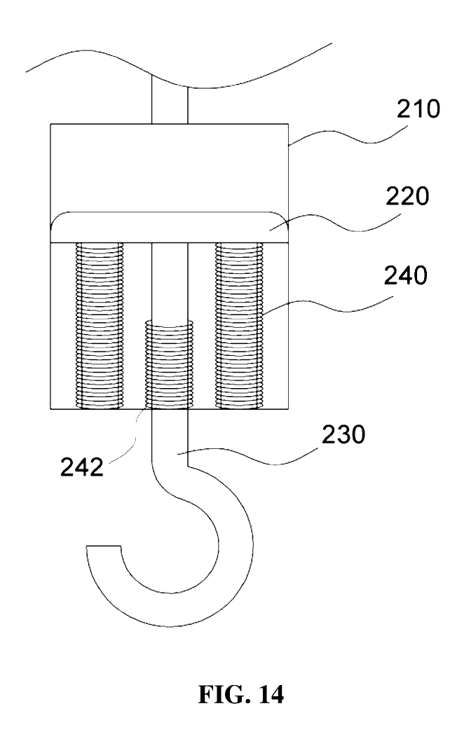

Meanwhile, FIG. 14 shows another embodiment of the present invention, wherein two lower elastic members 240 are provided and a shock absorbing means 242 is formed in the shape of a spring and has a length shorter than that of the lower elastic member 240.

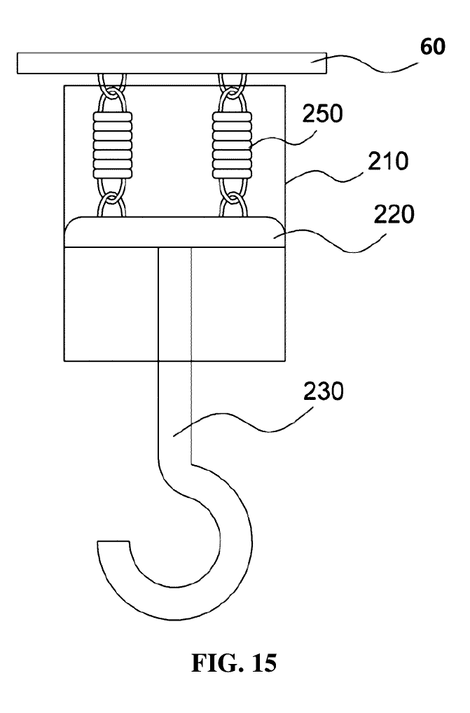

FIG. 15 shows an embodiment, wherein two upper elastic members 250 are provided and no shock absorbing means is provided. In this case, the speed decrease function of the vertical movement part 220 cannot be exhibited. It is also possible to apply and provide a member, which corresponds to the shock absorbing means shown in FIG. 12 or FIG. 13, to the embodiment of FIG. 15.

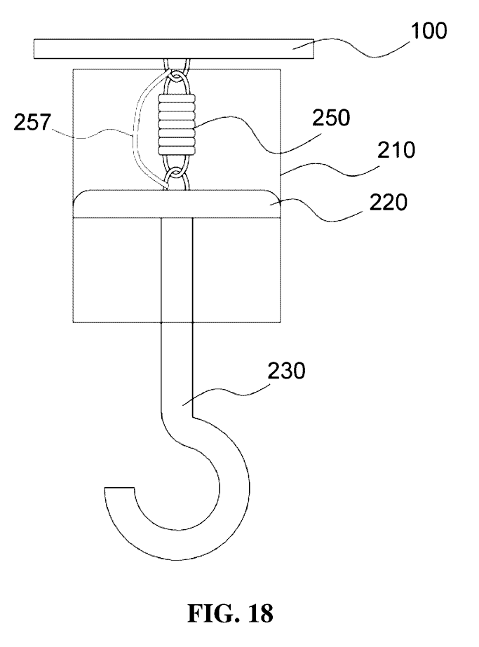

FIG. 18 shows another embodiment, which is almost the same as the embodiment shown in FIG. 13 except a shock absorbing means 257, which is made from an elastic material and provided in a rope shape. However, it is the shock absorbing means 257 is not necessarily limited to the rope shape but may be replaced with a spring or any other element in various shape as far as the element can exhibit elastic force.

The length of the rope-shaped shock absorbing means 257 has to be formed to be longer than the neutral state length of the upper elastic member 250, in which the upper elastic member 250 is neither extended nor contracted (a state before an external force is applied), and the reason is as follows.

That is, if the vertical movement part 220 is moved downwards by the weight of a user, the vertical movement part 220 is applied with the elasticity of the upper elastic member 250. Then, the length of the upper elastic member 250 is extended such that the vertical movement part 220 is simultaneously applied with the elastic force of both of the shock absorbing means 257 and the upper elastic member 250 from a time point, when the length of the upper elastic member 250 becomes the same as the length of the shock absorbing means 257.

Therefore, the downward movement speed of the vertical movement part becomes gradually decreased and the vertical movement part is stopped when the vertical movement part elastic member reaches the inner bottom surface of the constraint means 210.

Herein, the elastic member constraint means 210 serves as a kind of a stopper for preventing the upper elastic member 250 and the shock absorbing means 257 from being extended any more. Herein, the elastic member constraint means 210 carries out the same function as the elastic member constraint means 20 of FIG. 3, which is formed in a rope-shape from a non-elastic material and controls the length of the elastic member 10 so as to prevent the further extension thereof.

The shock absorbing means may be formed at the lower side of the vertical movement part 220, like the shock absorbing means 245 of FIG. 12 and FIG. 13, or at the upper side of the vertical movement part 220, like the shock absorbing means 257 of FIG. 18.

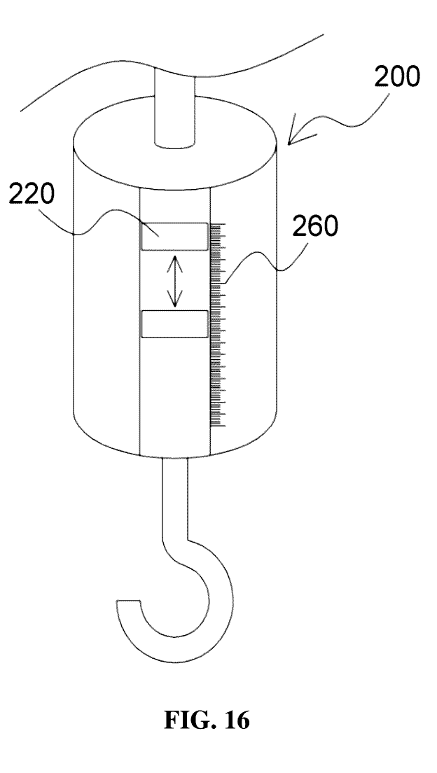

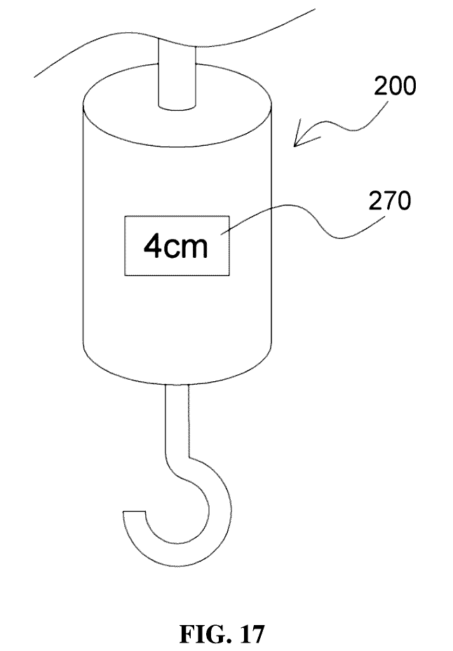

FIG. 16 shows an embodiment, in which a scale is formed on the outer surface of the elastic force providing means 200. In addition, FIG. 17 illustrates an embodiment, in which a digital indicator is provided.

As shown in FIG. 16, a scale 260 may be formed on the outer surface of the elastic force providing means 200 so as to check the movement distance of the vertical movement part 220. That is, when a walker carries out walking exercise, a manager can check the width of the vertical motion.

A normal person moves about 4 cm in the horizontal direction with a height change of about 5 cm in the vertical direction during the walking. Therefore, if the walking exercise is carried out in the range of 5 cm in the vertical direction during the walking, it may be determined that normal walking is carried out.

If the height change exceeds the above range, the walking exercise is not normally carried out. Therefore, it is possible to induce to take appropriate measures accordingly.

Meanwhile, as shown in FIG. 17, it is possible to provide a digital indicator 270, instead of the scale, for digitally indicating the movement distance of the vertical movement part 220.

The digital indicator is typically structured as follows in order to indicate height.

That is, the digital indicator 270 can indicate the movement distance of the vertical movement part by using a height measurement sensor, a central processing unit for obtaining a measurement value, which is measured by the height measurement sensor, and a data output unit for outputting a result value, which is determined by the central processing unit, to a panel.

If the scale or the digital indicator is structured as above, it is possible to check any height change by the scale or the digital indicator such that whether normal walking motion or abnormal walking motion is carried out can be immediately checked and corresponding information can be collected so as to be used as research data.

As described above, while the present invention has been particularly shown and described with reference to the example embodiments thereof, it will be understood by those of ordinary skill in the art, to which the present invention belongs, that the above embodiments of the present invention are all exemplified and various changes, modifications and equivalents may be made therein without changing the technical idea or essential characteristics of the present invention. Therefore, the embodiments described above should be understood as not limitative but illustrative in every respect.

1. In a walking assistance device comprising an elastic force providing means, which includes: an elastic member (10), of which an upper portion is connected to a frame (60) of a walking motion assistance device and a lower portion is connected to a safety belt (50) which a user puts on his waist; an elastic member constraint means (20) vertically formed in parallel to the elastic member (10); and a shock absorbing means (15) vertically formed in parallel to the elastic member and made from an elastic material, the walking assistance device characterized in that:
the shock absorbing means (15) is formed such that a neutral state length of the shock absorbing means (15), in which the shock absorbing means (15) is neither extended nor contracted, is longer than a neutral state length of the elastic member, in which the elastic member is neither extended nor contracted; and
the elastic member constraint means (20) is formed such that a neutral state length of the elastic member constraint means (20), in which the elastic member constraint means (20) is neither extended nor contracted, is longer than the neutral state length of the shock absorbing means, in which the shock absorbing means is neither extended nor contracted.

2. A walking assistance device, comprising an elastic force providing means, wherein the elastic force providing means includes:
an elastic member (10), of which an upper portion is connected to a frame (60) of a walking motion assistance device and a lower portion is connected to a safety belt (50) which a user puts on his waist; and
an elastic member constraint means (20) formed to neighbor the elastic member (10).

3. The walking assistance device according to claim 2, wherein
the elastic member constraint means (20) is formed in the same vertical direction as the elastic member (10), and
the elastic member (10) is formed to be spaced from the elastic member constraint means (20), or formed into a shape, in which the both end portions of the elastic member (10) are joined to the elastic member constraint means (20), or formed into a shape, in which the elastic member (10) is joined to one side point of the elastic member constraint means (20).

4. The walking assistance device according to claim 2, wherein
the length of a portion in a body part of the elastic member constraint means (20), which is formed to neighbor the elastic member (10), is formed to be longer than the neutral state length of the elastic member (10), in which the elastic member (10) is neither extended nor contracted.

5. The walking assistance device according to claim 2, wherein
a suspension belt spacing means (30) is further formed at a position between the safety belt (50), which a user wears, and the walking motion assistance device (60), and
the positions of the elastic member and the elastic member constraint means are formed between the suspension belt spacing means (30) and the frame (60), or between the suspension belt spacing means (30) and the safety belt (50).

6. In a walking assistance device, which is connected to a frame (60) of the walking assistance device in the upward direction and a safety belt (50) for surrounding a body part of a patient in the downward direction, the walking assistance device comprising an elastic force providing means (200), which includes:
an elastic member constraint means (210) having a vertical movement part (220), which is provided to an internal space of the elastic member constraint means (210) and coupled to an upper end portion of a lower connection part (230);
a vertical movement part (220) provided to the inside of the elastic member constraint means so as to move vertically;
a lower connection part (230) coupled to the lower side of the vertical movement part so as to be connected to an external member at one side; and
a lower elastic member (240), of which one side is coupled to a lower end of the vertical movement part (220) and the other side is coupled to a lower side surface in the elastic member constraint means (210) so as to provide elastic force.

7. In a walking assistance device, which is connected to a frame (60) of the assistance device in the upward direction and a safety belt (50) for surrounding a body part of a patient in the downward direction, the walking assistance device comprising an elastic force providing means (200), which includes:
an elastic member constraint means (210) having a vertical movement part (220), which is provided to an internal space of the elastic member constraint means (210) and coupled to an upper end portion of a lower connection part (230);
a vertical movement part (220) provided to the inside of the elastic member constraint means so as to move vertically;
a lower connection part (230) coupled to the lower side of the vertical movement part so as to be connected to an external member at one side; and
an upper elastic member (250), of which one side is coupled to an upper end of the vertical movement part (220) so as to provide elastic force.

8. The walking assistance device according to claim 6, further comprising: a shock absorbing means (245, 252) formed in the elastic member constraint means (210) and having elastic force so as to generate elastic force simultaneously with the lower elastic member (240) from a position where the vertical movement part (220) is lowered downwards by a predetermined distance and comes into contact with the shock absorbing means.

9. The walking assistance device according to claim 7, further comprising: a shock absorbing means (257) formed to be longer than the length of the upper elastic member so as to be connected to the upper elastic member (250) in parallel to the upper elastic member (250) and having elastic force so as to generate elastic force simultaneously with the upper elastic member (250) after the vertical movement part (220) is extended by a predetermined length.

10. The walking assistance device according to claim 6, further comprising at least one of a scale (260) for checking a movement distance of the vertical movement part or a digital indicator (270) for digitally indicating the movement distance of the vertical movement part, which is formed on the outer surface of the elastic force providing means (200).

11. The walking assistance device according to claim 3, wherein
a suspension belt spacing means (30) is further formed at a position between the safety belt (50), which a user wears, and the walking motion assistance device (60), and
the positions of the elastic member and the elastic member constraint means are formed between the suspension belt spacing means (30) and the frame (60), or between the suspension belt spacing means (30) and the safety belt (50).

12. The walking assistance device according to claim 4, wherein
a suspension belt spacing means (30) is further formed at a position between the safety belt (50), which a user wears, and the walking motion assistance device (60), and
the positions of the elastic member and the elastic member constraint means are formed between the suspension belt spacing means (30) and the frame (60), or between the suspension belt spacing means (30) and the safety belt (50).

13. The walking assistance device according to claim 7, further comprising at least one of a scale (260) for checking a movement distance of the vertical movement part or a digital indicator (270) for digitally indicating the movement distance of the vertical movement part, which is formed on the outer surface of the elastic force providing means (200).
